(19) United States
(12) Patent Application Publication
(10) Pub. No.: US 2020/0074437 A1
(43) Pub. Date: Mar. 5, 2020

(54) LONG-RANGE DECENTRALIZED MOBILE PAYMENT NETWORK USING BLUETOOTH

(71) Applicant: BLEU TECH ENTERPRISES, LLC, Los Angeles, CA (US)

(72) Inventor: SESIE K. BONSI, Los Angeles, CA (US)

(21) Appl. No.: 16/559,197

(22) Filed: Sep. 3, 2019

Related U.S. Application Data
(60) Provisional application No. 62/725,729, filed on Aug. 31, 2018.

(51) Int. Cl. G06Q 20/32; G06Q 20/08; G06Q 20/06

(52) U.S. Cl. CPC G06Q 20/325; G06Q 20/065; G06Q 20/0855

(57) ABSTRACT

A long-range payment network uses a mesh network that includes a plurality of mobile devices that communicate with each other via a low energy network protocol. The mobile devices comprise an app that determines a fewest number of hops in the network to reach a long-range gateway and routes payment information through the mesh network along a path that minimizes the number of hops. Relay nodes may be used to connect the mesh network with the long-range gateway. Payment transactions may be initiated by the payee customer using a mobile device with a payment app or by a merchant using a point of sale application. Decentralized nodes may be used to verify payments.

### CROSS REFERENCE

This application is a nonprovisional of and claims priority from U.S. Provisional Patent Application No. 62/725,729 filed Aug. 31, 2018, the entire contents of which are hereby incorporated by reference.

### FIELD OF INVENTION

The present invention relates generally to systems and methods for managing electronic payments made by customers. More particularly, the present invention relates to a proximity payment system and method for remote locations.

### BACKGROUND OF THE INVENTION

Traditional point of sale terminals comprise primarily a cash register that interfaces with separate hardware for entering purchases and receiving payment. Such hardware may include optical scanners such as bar code readers and QR code readers for quickly generating purchase orders. The legacy point of sale terminals also commonly include magnetic strip card readers for processing payments. However, these legacy systems do not allow for integration with mobile technology.

Wireless point of sale terminals have been developed. However, these have suffered from several deficiencies, including especially a large space profile, separate manufactures for various components that must be joined together. These older wireless point of sale terminals have been required to be compatible with specific processors.

Cellular and broadband networks don't extend into rural areas. These communities are excluded from digital financial and payment services. Financial inclusion for citizens in developing countries hinges on unreliable technology and infrastructure. Reliable data uptime, stable power grid, high speed data transfer, broadband, and 4G LTE cellular networks don't exist in these communities. Terrain and road access makes it difficult or impossible install cell towers or lay fiber. Also, building such infrastructure can be damaging to the land and ecosystem. Uncovered populations typically live in rural locations with low population densities, low per capita incomes and weak or non-existent enabling infrastructure such as electricity and high-capacity fixed communications networks. These characteristics have a profound adverse impact on all aspects the business case for mobile network expansion. The revenue opportunity for cellular in rural or remote locations can be a much as 10x lower than in an equivalent site in an urban area.

### SUMMARY OF THE INVENTION

According to one embodiment, the invention is a wireless Bluetooth mesh network that safely, securely, and efficiently transmits transaction data over long distances. The high-speed payment and data networking solution leverages Bluetooth and mesh network technology. Merchant and customer can exchange value using an application on a smartphone and a POS device. Users can exchange message, multimedia content, voice notes, voice calls. These data transactions are routed over Bluetooth using mesh networking on other user devices. With Bluetooth mesh networking, each phone is a communication node in the network that relays a signal. The transaction uses path of least resistance for shortest number of “hops” to reach a gateway. Long-range gateways connect to back end payments infrastructure. Gateways have light infrastructure costs and maintenance compared to cellular.

This data movement methodology can be used for payment, messaging, multimedia, content deliver, e-commerce, or a myriad of mobile experiences delivered to the end user over the Bluetooth network.

According to another embodiment, the invention is a long-range wireless payment network that has a first mobile device comprising a payment application. A second mobile device also has the payment application, whereby the first and second mobile devices may communicate with each other via a low energy network protocol using the payment application for an authorization of payment from a user of the first mobile device to a user of the second mobile device. A long-range gateway transmits the authorization of payment from the user of the first mobile device. A mesh network in communication with the first and second mobile devices includes a plurality of additional mobile devices that comprise the payment application, whereby the mesh network is adapted to form a first communication path between the long-range gateway and the first mobile device and a second communication path between the long-range gateway and the second mobile device. The payment application may determine a fewest number of hops between the additional mobile devices to reach the long-range gateway in order to form the first communication path. A relay node may form an alternative communication path with the long-range gateway if the mesh network is unable to form a first communication path

### BRIEF DESCRIPTION OF THE DRAWINGS

FIG. 1 is a schematic representation of a wireless payment network according to one embodiment of the present invention.

FIG. 2 is a picture illustrating a possible communication path in a mesh network.

FIG. 3 is a picture of a long-range gateway according to one embodiment of the present invention.

FIG. 4 shows a mobile device loaded with a point of sale (POS) app receiving payment via a credit card according to one embodiment of the invention.

FIG. 5 illustrates a payment network for a payment initiated at a point of sale using a credit card or bank card according to one embodiment of the present invention.

FIG. 6 is a schematic that illustrates acknowledgment of the payment initiated at the point of sale.

FIG. 7 is a chart showing the timing and devices associated with payment initiated at the point of sale.

FIG. 8 is a schematic illustrating initiation of payment at a POS from a user's device programed with a payment app according to one embodiment of the present invention.

FIG. 9 is a schematic illustrating a request sent to a payee for authorization of payment at a POS by a user with a device programed with a payment app according to one embodiment of the present invention.

FIG. 10 is a schematic illustrating authorization of payment at a POS by a user with a device programed with a payment app according to one embodiment of the present invention.

FIG. 11 is a schematic illustrating initiation of a payment transaction by a user with a mobile device programmed with a payment app according to one embodiment of the present invention.

FIG. 12 is a schematic illustrating a payment network for a payment initiated by a payor using a mobile device programmed with a payment app according to one embodiment of the present invention.

FIG. 13 is a schematic illustrating processing of a payment request initiated by a payor using a mobile device programmed with a payment app according to one embodiment of the present invention.

FIG. 14 is a chart showing the timing and devices associated with payment initiated by a payor using a mobile device programmed with a payment app.

FIG. 15 is a schematic illustrating initiation of peer-to-peer payment by a payee according to one embodiment of the invention.

FIG. 16 is a schematic illustrating approval of peer-to-peer payment by a payee.

FIG. 17 is a schematic illustrating a payment network that utilizes consensus nodes to verify payment transactions.

### DESCRIPTION OF PREFERRED EMBODIMENTS

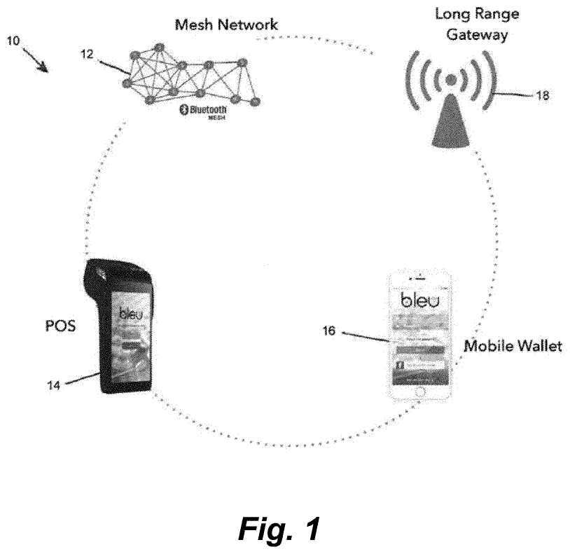

This invention is related to and builds upon the concepts disclosed in U.S. Pat. No. 10,192,213, the entire contents of which are hereby incorporated by reference. FIG. 1 shows a long-range decentralized wireless payment network 10 according to one embodiment of the present invention. The payment network 10 includes a mesh network 12 comprising a plurality of user devices that include low energy personal area network radios, such a Bluetooth Low Energy (BLE), and receivers. This description refers primarily to BLE radios and receivers, but other similar technologies may be used. A merchant may have a point of sale (POS) device 14 that includes a BLE (or similar) radio and receiver as well as a display screen and specialized software for handling purchase transactions as described in the '213 patent. Alternatively, the POS device 14 may be a mobile device, such as smart phone, that includes a software app for handling purchase transactions. A purchaser has a mobile device 16 that includes a payment application as described in the '213 patent for verifying and authorizing payment to the merchant. A long-range gateway 18, or series of gateways 18, are used to transmit the payment information to and from the payment source (e.g., bank or distributed ledger). The mesh network 10 therefore provides a mechanism for transporting data to and from the point of sale to the gateways 18, and the gateways 18 provide a mechanism for transporting data to and from the mesh network to the payment source.

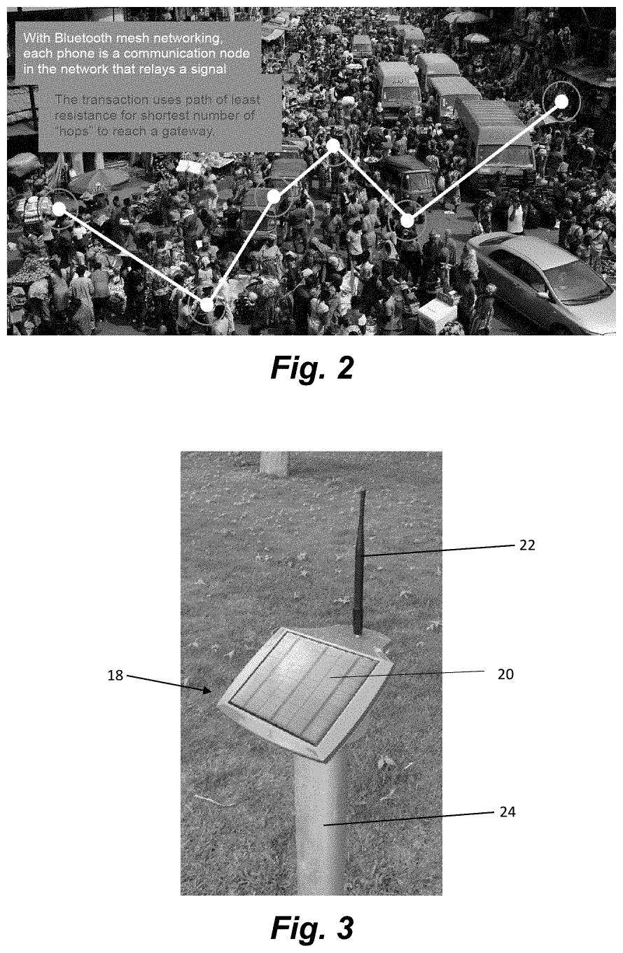

As seen in FIG. 2, each user's mobile device can act as a node in the network that relays signals to adjacent nodes to communicate information across the network. When a transaction is authorized, the application on each user's phone or node in the network will choose the shortest communication path to reach a gateway 18 to implement the transaction. Skilled users will be aware of appropriate algorithms for selecting the shortest communication path (e,g, fewest hops). The system may also include relay nodes 17 (see e.g., FIG. 5) that help transmit information from the mesh of mobile devices to the gateway 18. A relay node is a hardware device equipped with a long-range Bluetooth radio that acts as a long range router and transmits Bluetooth data thousands of meters at high speed. A relay node can be a proprietary base station or embedded within a ubiquitous device such as a street lamp, or a traffic sign. A relay node's purpose is to communicate the message a longer distance to the gateway 18 than hopping from device to device in the mesh could. Relay nodes should be close enough to communities where the transactions take plays so that the relay node can then relay the message a longer distance to the gateway rather than the message trying to hop all the way to the gateway if the mesh network 12 is not close enough to the gateway 18.

As seen in FIG. 3, the long-range gateways 18 may include solar panels 20 in order to be solar powered so that they can be used in areas that are off the power grid. The gateways 18 include long-range BLE radios and receivers that communicate through antennas 22 and are capable of connections of 1000 meters or more. Like the relay nodes, gateways 18 may be mounted on a proprietary base station 24 or embedded within a ubiquitous device such as a street lamp, or a traffic sign.

One features or elements of the present invention is a wallet application. The wallet application of the present invention is software that is downloaded on to a user's smart phone or similar mobile device. The wallet app has the ability to connect to nodes, relay nodes, and other access points in the network. Any device that has the wallet app can serve as a node in the network. Customer payment information is stored in the form of encrypted tokens that are handled by the wallet app. The clear text payment information of a user is never stored on the device.

Another feature of the present invention is a point of sale application (POS app). The POS app is software that may be provided on the POS device 14. The POS app gives the POS device the ability to communicate with user's devices that have the wallet app as well as with payment beacons, such as for example Net Clearance Bluetooth 5 payment beacons. The POS app also enables the POS device to take traditional card payments via magnetic strips or smart cards with integrate circuits (for example that use the EMV payment method).

At least a few different payment scenarios may use the long-range payment network 10. Under a first scenario, a merchant and customer are exchanging value for goods or services in proximity with one another. Payment data uses traditional internet protocols to reach a traditional payment server, such as a bank or credit card company server. The first scenario would proceed as follows:

1. Mobile User 1 (customer or purchaser) has downloaded a customer application onto a smartphone, or is distributed a smartphone with the application on it.

2. Mobile User 2 (merchant or seller) has either a POS application on a mobile device or smart phone in the same way as user 1, or they are a merchant with an all in one POS terminal with the payment application on it.

3. The customer or User 1 presents items or services for payment.

4. Merchant or User 2 inputs payment amount or purchase price into the POS application and finds User 1 from list of available users within proximity.

5. User 2 selects User 1 and initiates the payment request.

6. The BLE radio of User 2's device connects with the BLE radio of User 1's device and the payment request data passes to User 1.

7. User 1 is presented with the payment amount for confirmation.

8. User 1 confirms and authorizes payment using biometric authentication by voice, facial recognition, fingerprint, iris scan, or any other possible identification methods.

9. Once payment is confirmed the BLE radio on User 1's device attempts to reach the network for verification of transaction.

10. The payment applications both customer application and POS are embedded with Bluetooth mesh networking protocols.

11. The application will perform a multi-hop routing protocol to communicate with the gateway across multiple hops.

12. Each User that has the payment application is a node or a hop in the network.

13. Every time a user is in proximity of another user with a device, the application orients itself in the array in relation to the closest gateway in the array, given the updated position of the node it is passing.

14. Thus the application or the node knows the probability or the expected transmission count needed to reach the closest gateway.

15. The payment application will choose the shortest number of hops to reach gateway.

16. Gateways will be placed in 1000 m distances from one another, equipped with long-range BLE radios capable of connections of 1000 m between the receiver and the node.

17. Gateways will be solar powered.

18. The Gateway provides a BLE radio receiver capable of an infinite number of connections

19. The BLE Radio is connected to a microprocessor which transfers the BLE message to a CPU and the CPU transmits the message to a WiFi, Cellular, or broadband microprocessor.

20. The outgoing microprocessor connects with the server and the response message is sent back to the WiFi, Cellular, or broadband microprocessor, which takes its response route back to another BLE radio for transmission.

21. The transmitter BLE radio sends response message using algorithm for least possible transmission count needed to reach User 1 and User 2 devices.

22. User 1 and User 2 both receive verification message on their devices of successful transaction and balance in their mobile money accounts is reflected in the application.

According to a second scenario a merchant and customer are exchanging value for goods or services in proximity with one another and data is decentralized across network in a distributed ledger for verification of transaction. The second scenario would proceed as follows:

1. A a system of nodes (computers) connected in a network is used to verify and validate each transaction executed or submitted to the network, rather than using a central server or closed environment.

2. This system of nodes could be built using platforms such as blockchain or hashgraph or any other technologies for distributed ledgers.

3. The communication between the nodes are all computers on the internet, communicating by TCP/IP connections.

4. In another iteration the nodes are all devices or computers communicating over the Bluetooth mesh network rather than TCP/IP connections. The platform would not need to transmit messages to a WiFi, Cellular, or broadband access point. This creates a greater efficiency, meaning less computing power and consumption in order to inform the entire node network of an added transaction, and an increase in speed with the ability to process thousands or millions of transactions per second, and greater scale.

6. In this scenario the entire transaction and verification communication protocols are all built using the Bluetooth mesh stack.

7. If a user wished to perform a transaction that would require communication with a server or computer network outside of this completely decentralized Bluetooth network, there would be connected gateways/access points as in Scenario 1 that could convert the data packet to TCP/IP and route the package to the correct URL and response message back again.

8. Mobile User 1 has downloaded the customer payment application onto a smartphone, or is distributed a smartphone with the application on it.

9. Mobile User 2 has either the POS application in the same way as user 1, or they are a merchant with an all in one POS terminal with the payment application on it.

10. Just as is done in patent application Ser. No. 15/228,914, the customer or User 1 presents items or services for payment.

11. Merchant or User 2 inputs payment amount or purchase price into the Bleu POS application and finds User 1 from list of available users within proximity.

12. User 2 selects User 1 and initiates the payment request.

13. The BLE radio of User 2 device connect with the BLE radio of User 1 and the payment request data passes to User 1.

14. User 1 is presented with the payment amount for confirmation.

15. User 1 confirms and authorizes payment using biometric authentication by voice, facial recognition, fingerprint, iris scan, or any other possible identification methods.

16. Once payment is confirmed the BLE radio on User 1 device attempts to reach the network for verification of transaction.

17. The payment application for both the customer application and POS are embedded with Bluetooth mesh networking protocols.

18. As opposed to the scenario in scenario 1, the transaction hops are routed to the “verification” nodes on the Bluetooth network.

19. The verification nodes verify the transaction and confirm the validity of the users.

20. The ledger is updated with the verified transaction across all nodes.

21. User 1 and User 2 both receive verification message on their devices of successful transaction and balance in their mobile money accounts is reflected in the application.

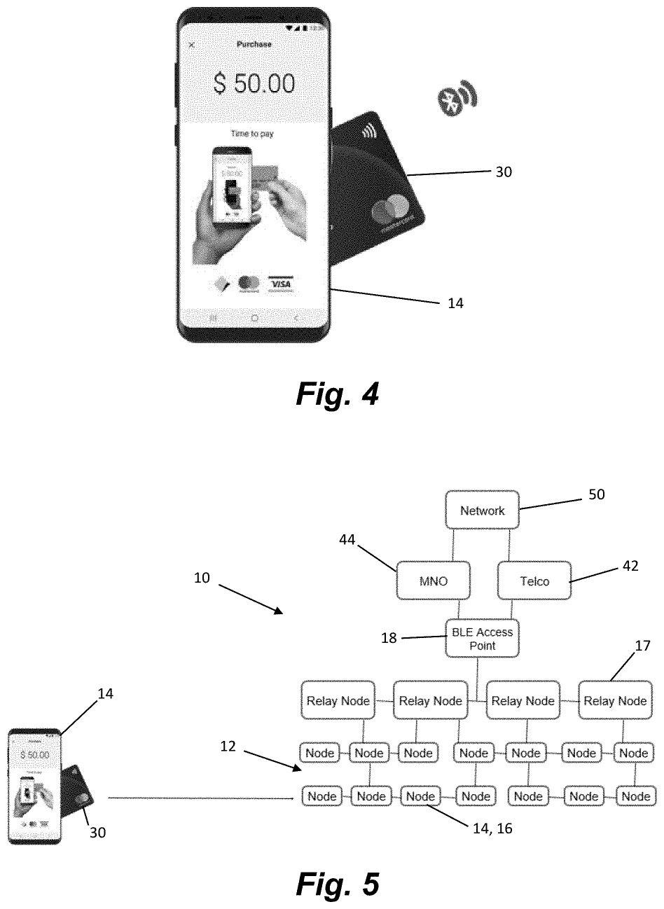

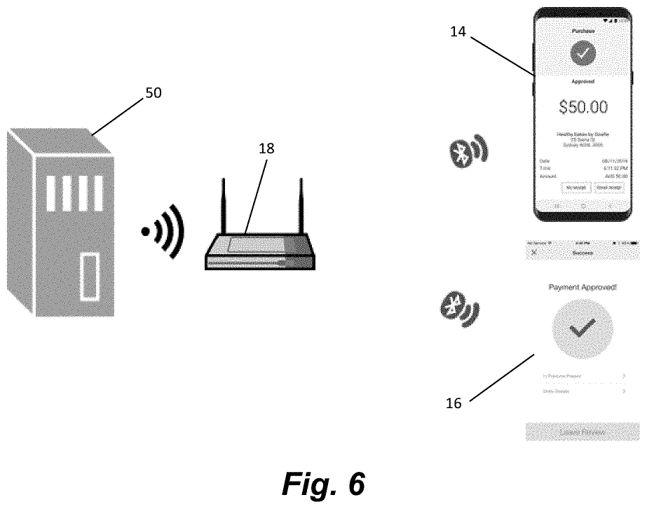

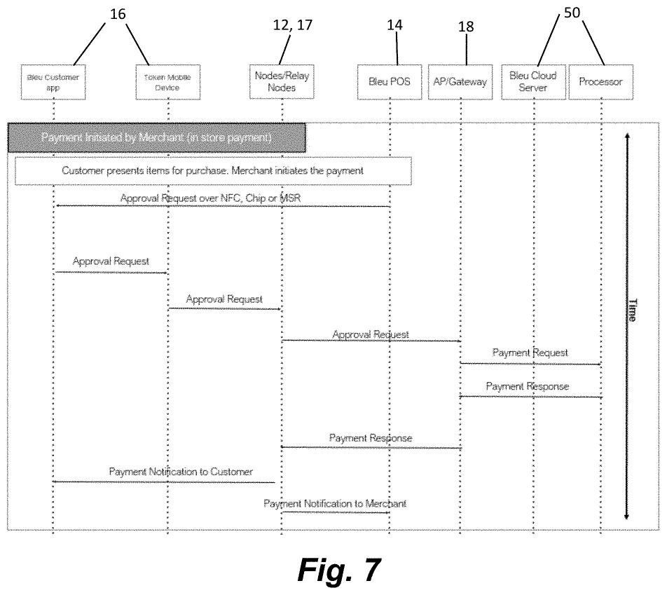

FIGS. 4-7 illustrate a payment transaction wherein a merchant initiates a credit or debit card sales transaction using a POS device 14 that includes the POS app. As noted above, the POS device may be dedicated specialized hardware as shown in the '213 patent, or may be a mobile device, such as a smart phone. The customer selects their items for purchase and presents them at the merchant POS device 14. The merchant inputs payment amount or purchase price into the POS app. The customer taps their NFC enabled payment card, mobile device, or dips their chip enabled card, or swipes their card 30 onto the merchant's POS device 14. A secure token is transmitted by the POS device 14 via Bluetooth communication protocol. Eventually the token is transmitted to the payment processor as shown in FIG. 5 for confirmation. As seen in FIG. 5, the token is first communicated to the mesh network via a BLE radio on the merchants POS device 14. attempts to reach the network for verification of transaction. The application will perform a multi-hop routing protocol to communicate with the AP/gateway 18 across multiple hops. Each user that has the wallet app on a mobile device 16 or POS application in a POS device 14 is a node or a hop in the network. Furthermore, relay nodes 17 may be provided to extend the reach of the mesh network as needed. Every time a user is in proximity of another user with a device, the application orients itself in the array in relation to the closest gateway in the array, given the updated position of the node (14, 16, 17) it is passing. Thus, the application or the node knows the probability or the expected transmission count needed to reach the closest gateway access point 18. The application will choose the shortest number of hops to reach a gateway access point 18. The gateway access point 18 provides a multi radio (Bluetooth and wifi or ethernet) beacon that has the capabilities to receive encrypted information (such as the token) from the relay nodes 17 or nodes 14, 16 via Bluetooth, wifi radio or ethernet, and then to the payment processing network 50 via a cellular provider 42 or broadband provider 44 that routes data using TCP/IP protocols. The gateway access point 18 thus acts as a pass-through device similar to a router. As illustrated in FIG. 6, the payment processing network 50 (e.g., network used to clear the payment with the credit card or bank server) returns the response (approved or declined) to the gateway access point 18, which in turn communicates the response to the merchant's POS device 18 and (if applicable) the customer's user device 16 via the long range Bluetooth network 12. FIG. 7 illustrates timing of the use of the various elements of the system.

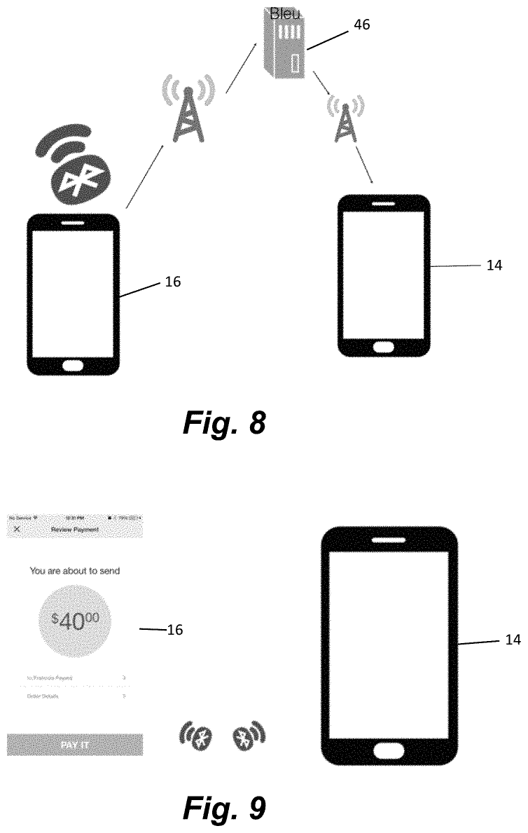

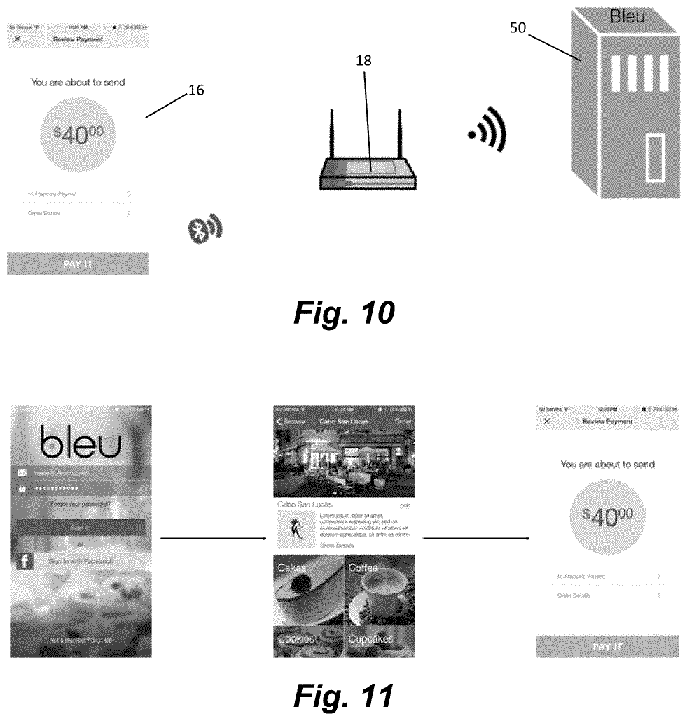

FIGS. 8-10 illustrate a payment transaction wherein a merchant initiates a sales transaction using a POS device 14 that includes the POS app when the customer is using a device 16 with the wallet app and a token to make the payment. As seen in FIG. 8, when the customer's device 16 enters the proximity of the merchant's device 14 the merchant's POS app connects through Bluetooth to the customer's wallet app which has a unique ID. This initiates a specific response from the app to the payment server 46, to check the customer in to that merchant and track their movement in the array of nodes or beacons. It can also initiate specific content such as an offer or coupon or marketing message. The customer's profile also appears inside the POS app. As seen in FIG. 9, the customer selects their items for purchase and presents them at the merchant POS device 14. The merchant inputs payment amount or purchase price into the POS app and finds the customer from list of available users within proximity. The BLE radio of customers device 16 connects with the BLE radio of the POS device 14 and the payment request data passes to the customers device 16. The payment approval is sent to the wallet app via Bluetooth to the customer for confirmation. As seen in FIG. 10, the customer selects their form of payment within the wallet app. The customer confirms and authorizes payment using biometric authentication by voice, facial recognition, fingerprint, iris scan, or any other possible identification methods. Once payment is confirmed the BLE radio on the customer's device 16 device attempts to reach the network 12 for verification of the transaction. The token and amount is sent over Bluetooth and the transaction proceeds as described and shown above relating to FIGS. 4-7 and a credit card transaction.

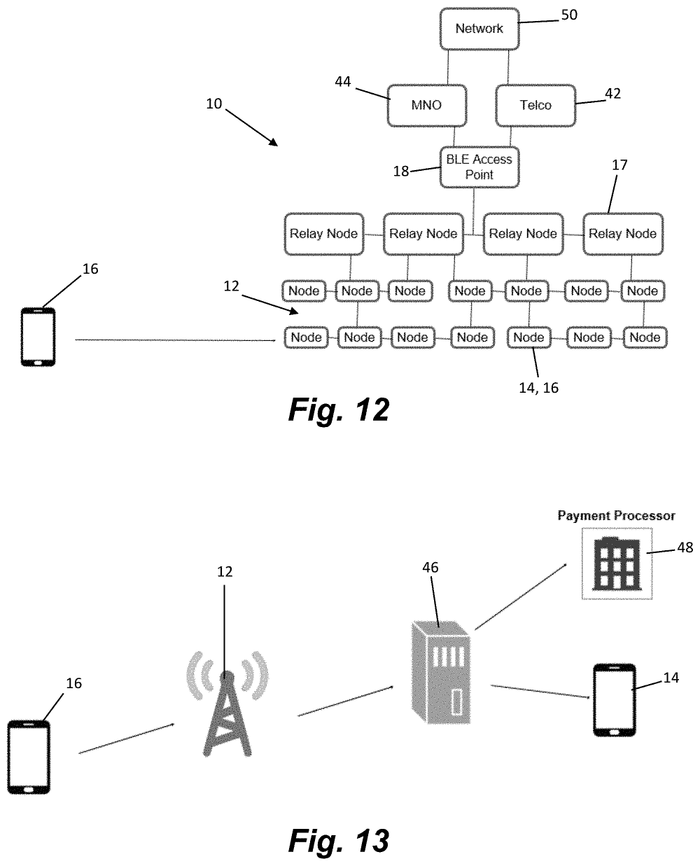

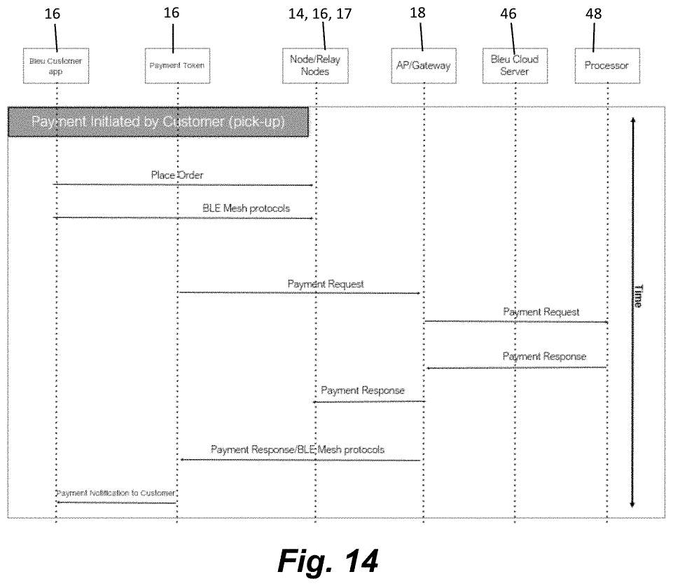

FIGS. 11-14 illustrate features of a payment transaction initiated by a customer that has the wallet app on their mobile device 16. In FIG. 11, the screen of the customer's device 16 is shown with various screens of the payment app displaying an initiation of the transaction. The customer first opens the payment app on their mobile device 16 and logs in. The customer finds the merchants mobile store-front inside the application and selects their items for purchase. The customer sends the order in the application. The customer selects Pay It in the application. The customer confirms and authorizes payment using biometric authentication by voice, facial recognition, fingerprint, iris scan, or any other possible identification methods. FIG. 12 is similar to FIG. 5 described above, except the long-range network 12 is contacted by the customer's device 16 instead of by the merchant's POS device 14 for verification of the transaction. As seen in FIG. 13, the customer's order is sent to the payment network 50 (including the payment server 46 and the bank or credit card server 48) via the long range network 12. The merchant is notified that an order has arrived on the POS device 14. The merchant selects the order from the incoming orders screen on the merchant interface. The merchant reviews the order and can either start the order or decline the order. The merchant is credited in their account with payment and the customer is debited in their account for the amount of the transaction in real time. FIG. 14 illustrates timing of the use of the various elements of the system during a transaction initiated by a customer's device 16.

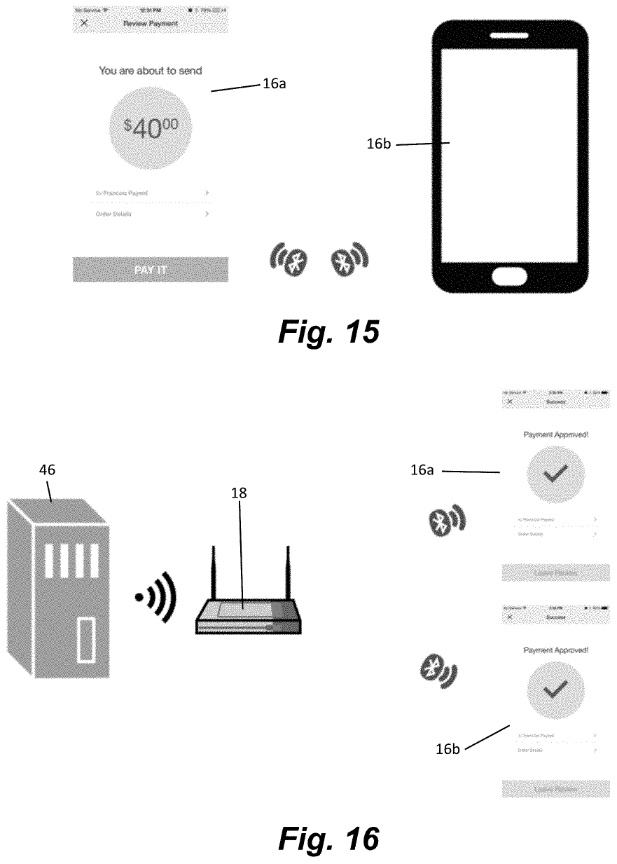

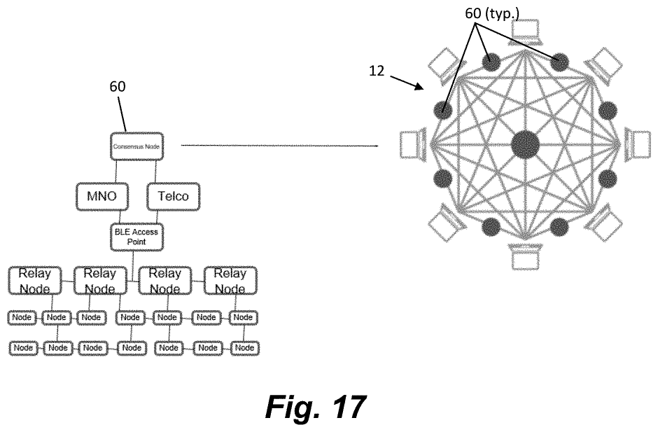

According to another feature of the present invention payment can be made directly between two users that have the payment app on their devices 16. This peer-to-peer payment transaction is illustrated in FIGS. 15 and 16. The device of the peer making the payment 16a inputs the payment amount into the payment application and finds the payee from list of available users within proximity. The payor confirms and authorizes payment using biometric authentication by voice, facial recognition, fingerprint, iris scan, or any other possible identification methods. The BLE radio of payor device 16a connects with the BLE radio of the payee 16b and the payment request data passes to the payee. The completed payment is sent to the network for confirmation. Approval (or disapproval) of the payment is sought through the network similar to the manner described with respect to FIGS. 5 and 12 related to payments made to merchants. When approved, the payment server 46 notifies the payor 16a and payee 16b devices via the long-range Bluetooth network. The funds are available immediately for payee in the wallet app.

According to another feature of the invention varication of a transaction may be accomplished by consensus nodes in a decentralized manner. This feature is illustrated in FIG. 17. Once payment is confirmed, the BLE radio on the customers device 16 attempts to reach the decentralized consensus nodes 60 within the mesh network 12 for verification of transaction. The payment app and the POS app are embedded with Bluetooth mesh networking protocols. The transaction hops are routed to the “verification” or consensus nodes 60 on the network 12. The verification nodes 60 verify the transaction and confirm the validity of the users. The ledger is updated with the verified transaction across all consensus nodes 60. This provides for quicker verification of transactions.

As an additional feature, the mobile devices 14, 16 running the payment app and the POS app can leverage the failover redundancy of the long-range network 12. The apps send data packets over BLE when cellular or wife are not available. The apps can then chunk the packets and connect with the closest node to begin the data transfer process in a piecemeal fashion over the network 12.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. A long-range wireless payment network comprising:
a first mobile device comprising a payment application;
a second mobile device comprising the payment application, whereby the first and second mobile devices may communicate with each other via a low energy network protocol using the payment application for an authorization of payment from a user of the first mobile device to a user of the second mobile device;
a long-range gateway for transmitting the authorization of payment from the user of the first mobile device; and
a mesh network in communication with the first and second mobile devices, the mesh network comprising a plurality of additional mobile devices that comprise the payment application, whereby the mesh network is adapted to form a first communication path between the long-range gateway and the first mobile device and a second communication path between the long-range gateway and the second mobile device.

2. The long-range wireless payment network of claim 1, wherein the payment application determines a fewest number of hops among the additional mobile devices to reach the long-range gateway in order to form the first communication path.

3. The long-range wireless payment network of claim 1, further comprising:
a relay node to form an alternative communication path with the long-range gateway if the mesh network is unable to form a first communication path.

4. The long-range wireless payment network of claim 1, wherein the mesh network comprises additional devices that form nodes in the mesh network, and further wherein some of the nodes are designated as consensus nodes, whereby the consensus nodes are adapted to verify transactions.

5. The long-range payment network of claim 4, wherein the consensus nodes are adapted to update a ledger upon verifying a transaction.

6. The long-range payment network of claim 4, wherein the ledger is updated with the verified transaction across all consensus nodes in the mesh network.
